(19) United States
(12) Patent Application Publication
(10) Pub. No.: US 2025/0346132 A1
(43) Pub. Date: Nov. 13, 2025

(54) DEVICE AND METHOD FOR PROTECTING AN ELECTRIC VEHICLE CHARGING PORT

(71) Applicant: BDG Solutions inc., Notre-Dame-des-Prairies (CA)

(72) Inventor: Benoît DE GRANDPRÉ, Notre-Dame-des-Prairies (CA)

(21) Appl. No.: 19/202,534

(22) Filed: May 8, 2025

(30) Foreign Application Priority Data
May 9, 2024 (CA) 3237958

(51) Int. Cl. B60L 53/16

(52) U.S. Cl. CPC B60L 53/16

(57) ABSTRACT

A removable protective device and method for protecting a charging port of an electric vehicle during electrical charging thereof with an electrical socket are disclosed. The removable protective device defines an outer perimeter configured in size to fit into or on the charging port and comprises an orifice passing through the removable protective device substantially at its center, and wherein the device is made of a compressible material. The orifice is sized to receive a handle of the electrical socket and to be held by said handle by compression, and the device once held by said socket handle enables the charging port to be closed and protected when the socket is inserted therein. The removable protective device is easy to use and protects the vehicle's electrical charging port from bad weather (rain, snow, ice, etc.) or external dirt (dust, sand, pollen, dead leaves, etc.).

### CROSS-REFERENCE TO RELATED APPLICATIONS

The present patent application claims the benefits of priority of Canadian patent application no. 3,237,958 filed on May 9, 2024, the content of which is enclosed herewith by reference.

### FIELD OF THE INVENTION

The present invention relates essentially to the field of mechanics, and more particularly to a device and a method for protecting a charging port of an electric vehicle during electrical charging thereof, in particular against bad weather (snow, rain, ice, etc.) or other elements potentially damaging to the charging port.

### BACKGROUND OF THE INVENTION

The battery of an electric vehicle needs to be recharged regularly via a charging port adapted to receive and connect a charging plug or socket connected to a source of electricity, for example via an electrical terminal. In general, the charging port is protected by a flap when the vehicle is not connected to the terminal. To charge the vehicle, open the flap before inserting the plug into the port.

It often happens that the vehicle and the charging station are located outside, and during charging, the charging port is no longer protected by the open flap and can therefore be subjected to the elements (rain, snow, ice, etc.) or external dirt (dust, sand, pollen, dead leaves, etc.). It can therefore become unpleasant and difficult for the user to remove the plug after charging, if the port is covered with snow, ice or the like. Furthermore, in northern countries with harsh winters, regular exposure to rain, ice or snow can lead to rapid degradation of the charging port.

At present, there are protective systems available which consist of a protective membrane that the user tries to block over the charging port to cover and protect it. However, it's not always easy to find a physical part of the vehicle where the membrane can be effectively secured in the right place. Furthermore, the membrane can easily be ripped off.

There is therefore a need for a new protective device that is easier to use and, above all, more effective than those currently on the market.

### SUMMARY OF THE INVENTION

The present invention relates firstly to a removable protective device for protecting a charging port of an electric vehicle when electrically charging the latter with an electrical socket, the device defining an outer perimeter configured in size to fit into the charging port and comprising a hole passing through the device substantially at its center, and wherein the device is made of a compressible material, the orifice is configured in size to receive the electrical socket or a handle thereof and to be held by said electrical socket or handle by compression, and the device once held by said electrical socket or handle thereof enables the charging port to be closed and protected when the electrical socket is inserted therein.

The present invention also relates to a method for protecting a charging port of an electric vehicle when electrically charging the same with an electrical socket, the method comprising:
provide a protective device comprising a compressible material and defining an outer perimeter sized to fit with the charging port;
inserting the electric socket or a handle of the electrical socket into a hole passing through the protective element substantially at its center, the hole being configured in size to receive and be held by said electric socket or handle by compression; and
insert the electric socket into the charging port while inserting the protective device held by the electric socket or the handle thereof into the charging port to close and protect the charging port.

The protective device is easy to use and protects the vehicle's electrical charging port from bad weather (rain, snow, ice, etc.) or external dirt (dust, sand, pollen, dead leaves, etc.). The shape of the outer edge of the protective device and the shape of the central hole of the device can be cut or precut to perfectly fit with the vehicle model and the socket's shape.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Further features and exemplary advantages of the present invention will become apparent from the following detailed description, taken in conjunction with the appended drawings, in which:

FIG. 1 is a photograph showing an electric charging socket and an unprotected, charging port covered by snow;

FIG. 2 is a photograph showing an unprotected, snow-free electrical charging socket and charging port;

FIG. 3 is an illustration of the protective device according to a preferred embodiment of the invention;

FIG. 4 is an illustration of the pressure-supported protective device on the charging socket according to a preferred embodiment of the invention;

FIG. 5 is an illustration of an electrical charging socket seen from above, fitted with a protective device and in relation to a charging port which will be protected by the device according to a preferred embodiment of the invention;

FIG. 6 is a photograph showing a protective device according to a preferred embodiment; and

FIG. 7 is the protective device illustrated on FIG. 6 installed on a charging port of an electrical vehicle.

### DETAILED DESCRIPTION OF PREFERRED EMBODIMENTS

A new protective device and its method of use will be described below. Although the invention will be described using one or more preferred embodiments as examples, it is important to understand that these preferred embodiments are used to illustrate the invention and not to limit its scope.

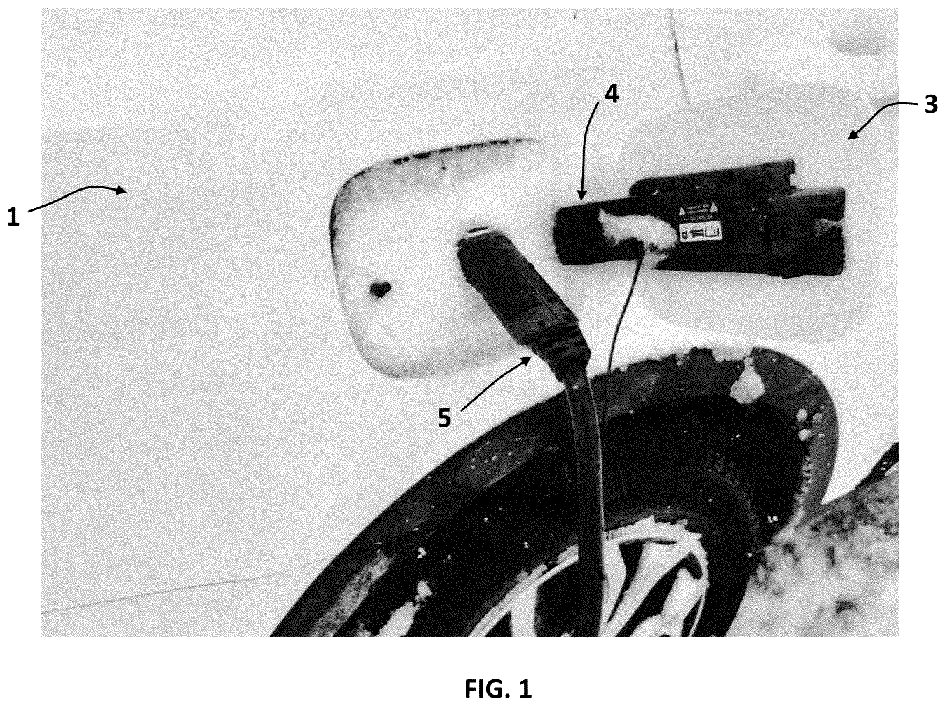

As illustrated in FIG. 1, it often happens that a vehicle 1 and the charging station (not shown) are located outdoors, and during charging, the charging port is no longer protected by the flap 3 (connected to the vehicle body by a hinge 4), which in this case remains open during charging, and can therefore be subjected to bad weather (rain, snow, ice, etc.) or external dirt (dust, sand, pollen, dead leaves, etc.). FIG. 1 illustrates the charging port covered by snow.

It can therefore become unpleasant and difficult for the user to remove the electrical plug or socket 5 once charging is complete, if the charging port is covered in snow, ice or the like. Furthermore, in northern countries with harsh winters, regular exposure to rain, ice or snow can lead to rapid degradation of the charging port.

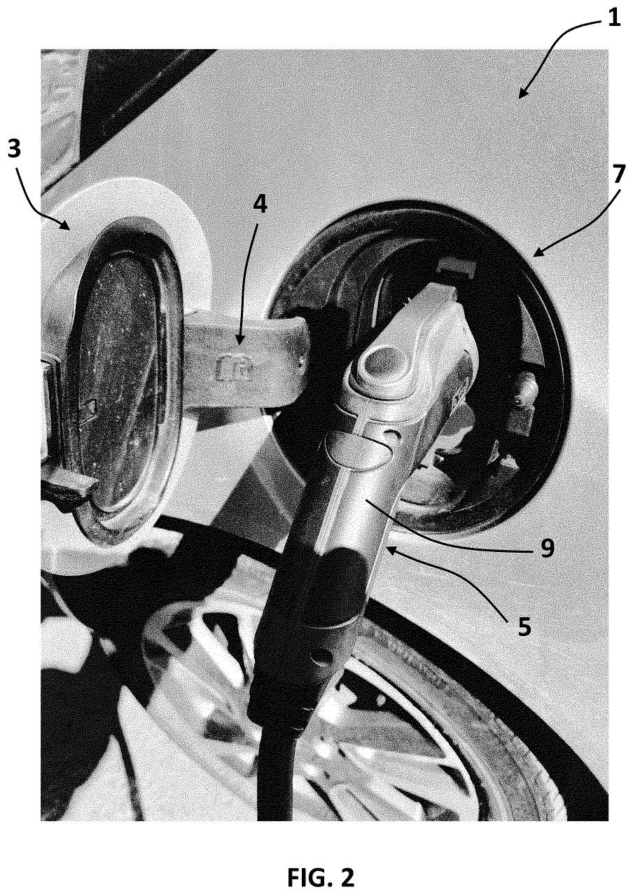

FIG. 2 illustrates a charging port 7 of the vehicle 1 that is not covered in snow, and into which the electrical socket 5 fitted with a handle 9 is inserted.

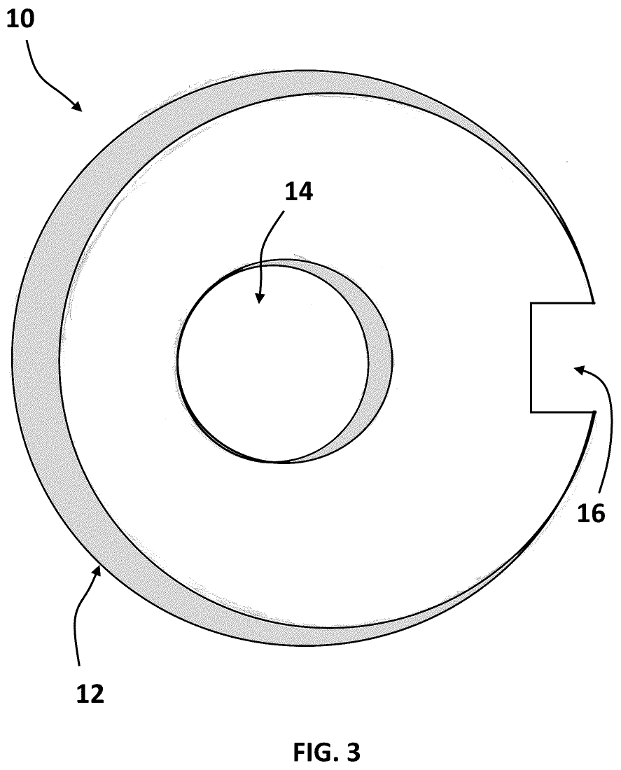

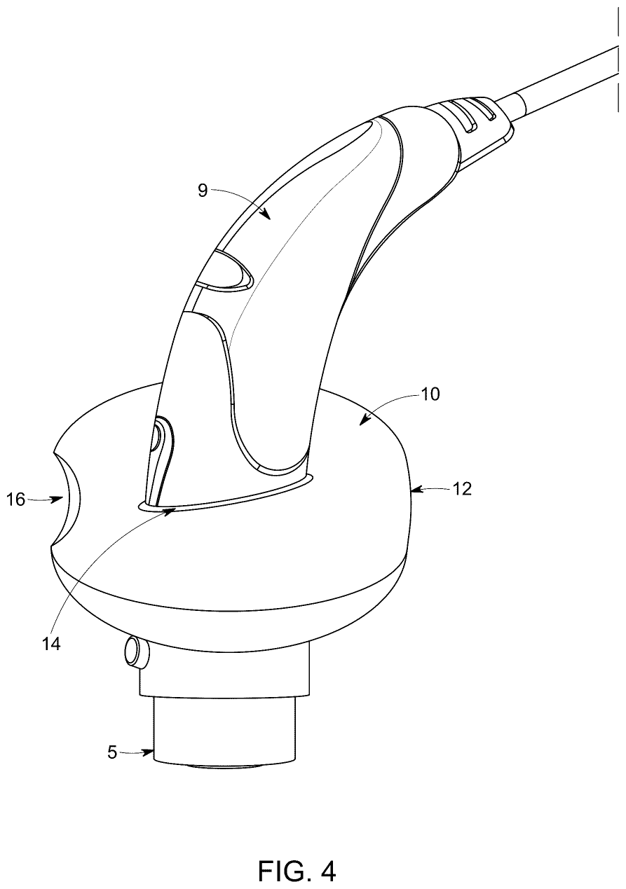

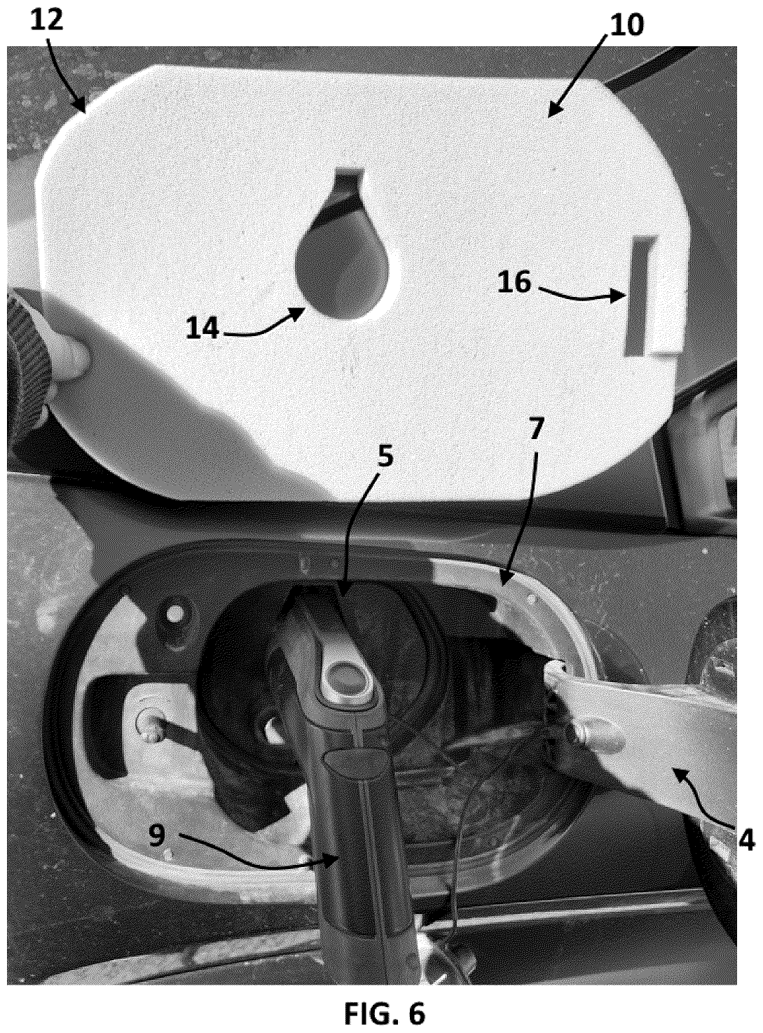

The inventor has therefore designed a new removable protective device 10, to protect a charging port of an electric vehicle during electrical charging of the latter with an electrical socket, a non-limiting example of which is illustrated in FIGS. 3 to 7.

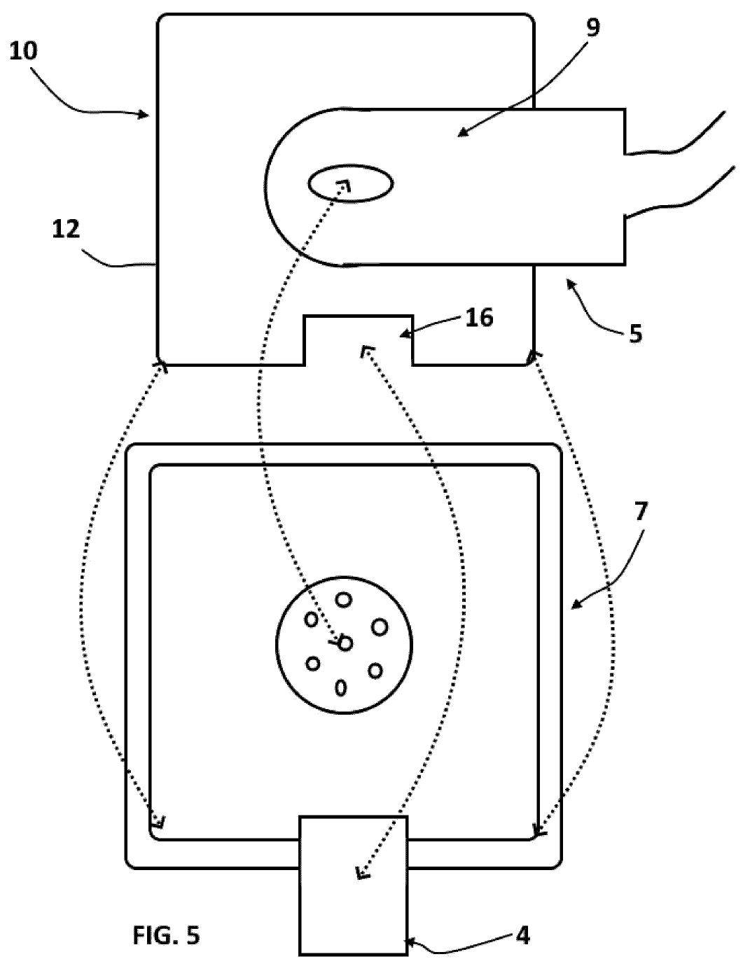

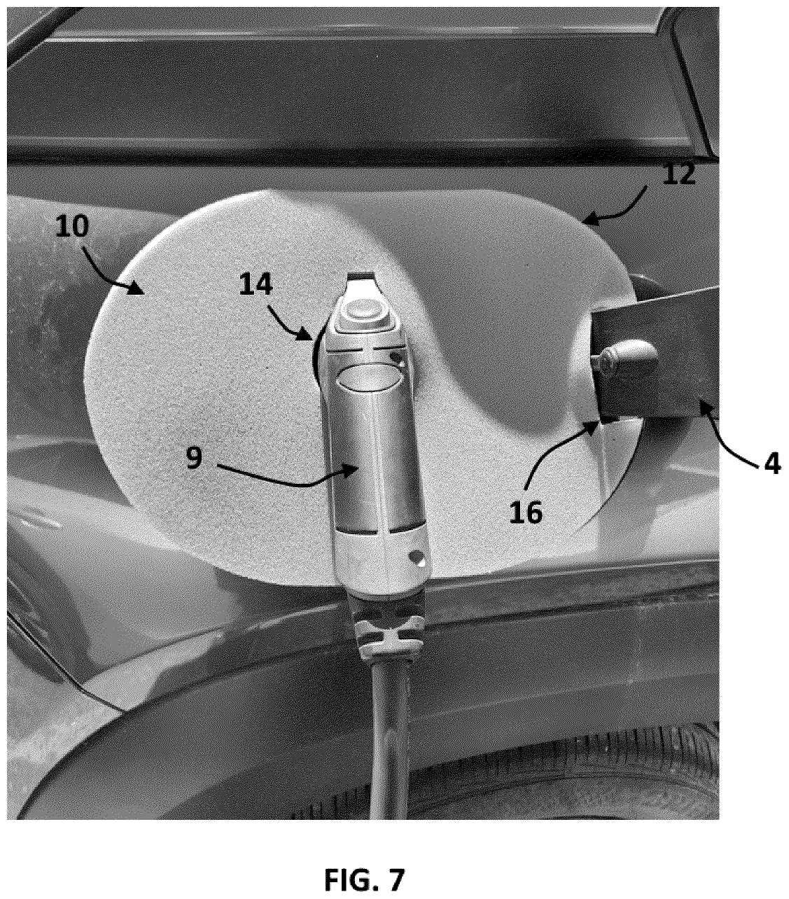

According to a preferred embodiment, the protective device 10, such as that illustrated in FIGS. 3 to 7, defines an external perimeter 12 configured in size to fit into the charging port 7 and comprising an orifice 14 passing through the device substantially at its center. To be functional, the device 10 is made of a compressible material, having sufficient elasticity so that the orifice 14 of the device 10, whose size is configured to receive the handle 9 of the electrical socket 5, can hold the device 10 in place by compression of the material on the handle. Once held by said handle 9 the device closes and protects the charging port 7 when the socket 5 is inserted into it, as illustrated in FIG. 5 or 7.

Preferably, the compressible material comprises a polymeric material, such as polyurethane, preferably in the form of foam. Any other material that is compressible and sufficiently strong to enable the device to be both retained by the handle by friction/pressure, and inserted into the charging port, can be used without departing from the scope of the present invention.

According to a preferred mode of the invention, as illustrated in FIGS. 3-7, but in particular in FIGS. 5 and 7, the removable protective device 10 can also comprise a notch 16 whose dimension is chosen to accept the hinge 4 of the flap 3 closing the charging port 7.

According to a preferred embodiment, the outer perimeter 12, the hole 14 and/or the notch 16 of the device 10 can be precut by laser to increase the precision of the cut according to the model of the electrical port to be protected. In fact, the perimeter of the device can be pre-cut to the desired shape according to the vehicle model to adapt to the shape of the charging port of this type of vehicle. The present invention is not limited to the shape of the device illustrated in the figures.

The protective device described in the present application makes it possible to protect a charging port of an electric vehicle 1 when electrically charging the same with an electric socket 5. The method according to a preferred mode of the invention comprises at least the following steps:
be provided with a protective device 10, such as the one described here, comprising a compressible material and defining an outer perimeter 12 configured in size to fit into the charging port 7 of the vehicle 1;
inserting a handle of the electrical socket into a hole 14 passing through the protective device 10 substantially at its center, the hole being configured in size to receive and be held by the handle 9 of the electrical socket 5 by compression; and
insert the electrical socket 5 into the charging port 7 while inserting the protective device 10, held on the plug handle, into charging port 7 to close and protect the charging port.

Advantageously, the protective device described herein is easy to use in that it is held in a good operating position by the charging port. Unlike a protective membrane known in the field, the protective device described here cannot be removed without removing the electrical plug from the charging port.

In addition, the compressible material used to manufacture the device enables it to be held both in an effective operating position on the handle and once inserted into the charging port. If required, the shape of the perimeter can be easily modified, for example by cutting the material, to adapt to the shape of the port to be protected according to the vehicle model. Of course, the shape of the device can also be pre-cut at the factory for a specific model of charging port depending on the make of vehicle.

The preferred forms of the invention described above are to be used as illustration only and should not be utilized in a limiting sense in interpreting the scope of the present invention. Obvious modifications to the exemplary embodiments, as hereinabove set forth, could be readily made by those skilled in the art without departing from the scope of the present invention.

1. A removable protective device for protecting a charging port of an electric vehicle when electrically charging the same with an electrical socket, the device defining an outer perimeter configured in size for insertion into the charging port and comprising a hole passing through the device substantially at its center, and wherein:
the removable protective device is made of a compressible material;
the hole is sized to receive the electrical socket and a handle of the electrical socket and to be held by said electrical socket or handle by compression; and
the removable protective device, once held by said electrical socket or handle, closes and protects the charging port when the electrical socket is inserted into the charging port.

2. The removable protective device according to claim 1, wherein the compressible material comprises a polymeric material.

3. The removable protective device according to claim 2, wherein the compressible material comprises polyurethane.

4. The removable protective device according to claim 3, wherein the polyurethane is in the form of foam.

5. The removable protective device according to claim 1, wherein the perimeter of the protective device comprises a notch of a size and shape adapted to receive a hinge of a vehicle flap for closing the charging port when the vehicle is not loaded, so as to allow the protective device to fit into and protect the charging port.

6. The removable protective device according to claim 1, wherein the compressible material is pre-cut by laser to increase the precision of the cut according to the pattern of the electrical port to be protected and/or the hole of the electrical socket.

7. The removable protective device according to claim 5, wherein the compressible material is pre-cut by laser to increase the precision of the cut according to the pattern of the electrical port to be protected and/or the hole of the electrical socket.

8. A method for protecting a charging port of an electric vehicle when electrically charging the same with an electrical socket, the method comprising:
provide a protective device comprising a compressible material and defining an outer perimeter sized to fit into the charging port;
inserting the electrical socket or a handle thereof into a hole passing through the protective device substantially at its center, the hole being configured in size to receive and be held by said electrical socket or handle by compression; and
inserting the electrical socket into the charging port while inserting the protective device held by the electrical socket or the handle into the charging port to close and protect the charging port.

9. The method according to claim 8, wherein the compressible material comprises a polymeric material.

10. The method according to claim 9, wherein the compressible material comprises polyurethane.

11. The method according to claim 10, wherein the polyurethane is in the form of foam.

12. The method according to claim 8, wherein the compressible material is pre-cut by laser to increase the precision of the cut according to a pattern of the electrical port to be protected and/or the hole of the electrical socket.
